(19) United States
(12) Patent Application Publication
(10) Pub. No.: US 2016/0354865 A1
(43) Pub. Date: Dec. 8, 2016

(54) Microchamber laser processing systems and methods using localized process-gas atmosphere

(71) Applicant: Ultratech, Inc., San Jose, CA (US)

(72) Inventor: James T. McWhirter, San Jose, CA (US)

(73) Assignee: Ultratech, Inc., San Jose, CA (US)

(21) Appl. No.: 15/145,833

(22) Filed: May 4, 2016

Related U.S. Application Data
(60) Provisional application No. 62/172,701, filed on Jun. 8, 2015.

(51) Int. Cl. B23K 26/12; B23K 26/00

(52) U.S. Cl. CPC B23K 26/125; B23K 26/0066; B23K 26/1224

(57) ABSTRACT

Microchamber laser processing systems and methods that use a localized process-gas atmosphere are disclosed. The method includes processing a substrate with a surface by providing a process gas to a central region of the microchamber that includes the surface of the substrate and providing a curtain gas to a peripheral region of the chamber that includes the surface of the substrate. The method also includes providing a vacuum to a region of the chamber between its central and peripheral regions of the chamber, wherein the vacuum removes the process gas and curtain gas, thereby forming a localized process-gas atmosphere at the surface of the substrate in the central region of the chamber and a gas curtain of the curtain gas in the peripheral region of the chamber. The method also includes irradiating the surface of the substrate through the localized process-gas atmosphere with a laser beam that forms a laser line to perform a laser process on the surface of the substrate.

### CROSS-REFERENCE TO RELATED APPLICATIONS

This Application claims priority under 35 USC §119(e) from U.S. Provisional Patent Application Ser. No. 62/172,701, filed on Jun. 8, 2015, and which is incorporated by reference herein.

### FIELD

The present disclosure relates to laser processing of semiconductor substrates, and in particular relates to a microchamber laser processing systems and methods using a localized process-gas atmosphere.

The entire disclosure of any publication or patent document mentioned herein is incorporated by reference, including U.S. 2014/0151344 entitled “Movable microchamber with gas curtain,” and which is referred to below as the '344 publication, and U.S. Pat. No. 5,997,963 entitled “Microchamber,” which is referred to below as the '963 patent.

### BACKGROUND

Conventional process chamber systems used in semiconductor manufacturing are relatively large and stationary and need to be filled with far more reactant or gas than is actually necessary to carry out a particular process step on a semiconductor substrate. Further, some gas species are caustic while others are toxic, and therefore using minimal amounts of such gas is preferred.

To this end, microchamber systems have been developed as disclosed in the '344 publication and the '963 patent. The microchamber system has a relatively small-volume chamber (“microchamber”) that seals a process gas within the microchamber for processing. The '963 patent utilizes a gas curtain to seal off the microchamber from the outside environment while also allowing for a semiconductor substrate to move relative to the microchamber while the surface of the semiconductor substrate is laser processed.

In some instances, it is desirable to perform laser processing of a semiconductor substrate to incorporate nitrogen into the film stack, such as a high-k dielectric film, used for example as a gate dielectric layer in transistor devices to replace the conventional silicon dioxide dielectric layer. In a conventional silicon dioxide (SiO₂) gate, incorporating nitrogen to form an oxynitride layer increases the effective dielectric constant and acts as a barrier against dopant diffusion.

The formation of oxynitride films requires thermal annealing in the presence of nitrogen in its monatomic form (N) rather than N₂, which is relatively difficult to dissociate. One source of nitrogen besides N₂ is ammonia (NH₃), which is relatively easy to dissociate to obtain monatomic N. Unfortunately, ammonia is hazardous and so needs to be contained during processing. In this regard, it would be preferable to be able to contain ammonia and like process gasses in a localized region of a microchamber where the laser process actually takes place while limiting the amount of process gas leaking into the ambient environment to be below the allowable parts-per-million safety threshold for the particular process gas.

### SUMMARY

An aspect of the disclosure is a microchamber system for processing a surface of a substrate. The microchamber system includes: a top member having at least one optical-access feature sized to accommodate a laser beam that forms a laser line at the surface of the substrate; a movable stage assembly spaced apart from and that moves relative to the top member to define a chamber having a central region and a peripheral region, the movable stage assembly including a chuck that supports the substrate; a process-gas supply that contains a process gas and that is operably connected to the central region of the chamber by at least one process-gas conduit; a curtain-gas supply that contains a curtain gas and that is operably connected to the peripheral region of the chamber by at least one curtain-gas conduit; and a vacuum system operably connected to the chamber by at least one vacuum conduit that resides radially between the at least one process gas conduit and the at least one curtain-gas conduit so that when the process gas and the curtain gas are respectively flowed into the central and peripheral regions of the chamber, a localized process-gas atmosphere is formed in the central region of the chamber and a gas curtain of the curtain gas is formed in the peripheral region of the chamber.

Another aspect of the disclosure is the microchamber system as described above, and further including a laser source that forms the laser beam, wherein the laser source is operably arranged outside of the chamber and relative to the optical-access feature.

Another aspect of the disclosure is the microchamber system as described above, wherein the curtain gas consists of one or more gasses selected from the group of gases consisting of: nitrogen, argon, helium and neon.

Another aspect of the disclosure is the microchamber system as described above, wherein the process gas is one or more gasses selected from the group of gases consisting of: NH₃, N₂O, NO₂ and an H₂/N₂ mixture.

Another aspect of the disclosure is the microchamber system as described above, wherein the process gas consists of ammonia and water vapor.

Another aspect of the disclosure is the microchamber system as described above, wherein the at least one curtain-gas conduit includes a radially arranged array of curtain-gas conduits that run through the top member, wherein the at least one vacuum conduit includes a radially arranged array of vacuum conduits that run through the top member, and wherein the radially arranged array of vacuum conduits is concentric with and resides within the radially arranged array of curtain-gas conduits.

Another aspect of the disclosure is a method of laser processing a surface of a substrate movably supported in a chamber of a microchamber system. The method includes: providing a process gas to a central region of the chamber that includes the surface of the substrate; providing a curtain gas to a peripheral region of the chamber that includes the surface of the substrate; providing a vacuum to a region of the chamber between the central and peripheral regions of the chamber, wherein the vacuum removes process gas and curtain gas thereby forming a localized process-gas atmosphere adjacent the surface of the substrate in the central region of the chamber and a gas curtain of the curtain gas in the peripheral region of the chamber; and irradiating the surface of the substrate through the localized process-gas atmosphere with a laser beam that forms a laser line to perform a laser process on the surface of the substrate.

Another aspect of the disclosure is the method as described above, further includes moving the substrate relative to the laser beam so that the laser line scans over the surface of the substrate.

Another aspect of the disclosure is the method as described above, wherein the process gas includes ammonia.

Another aspect of the disclosure is the method as described above, wherein the process gas consists of ammonia and water vapor.

Another aspect of the disclosure is the method as described above, wherein the process gas is nitrogen-based, and wherein the laser process forms a nitride-based oxide film on the surface of the substrate.

Another aspect of the disclosure is the method as described above, wherein the process gas is selected from the group of gases consisting of: NH₃, N₂O, NO₂, and an H₂/N₂ mixture.

Another aspect of the disclosure is the method as described above, wherein the curtain gas consists of one or more gasses selected from the group of gases consisting of: nitrogen, argon, helium and neon.

Additional features and advantages will be set forth in the Detailed Description that follows and in part will be readily apparent to those skilled in the art from the description or recognized by practicing the embodiments as described in the written description and claims thereof, as well as the appended drawings. It is to be understood that both the foregoing general description and the following Detailed Description are merely exemplary and are intended to provide an overview or framework for understanding the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s) and together with the Detailed Description serve to explain principles and operation of the various embodiments. As such, the disclosure will become more fully understood from the following Detailed Description, taken in conjunction with the accompanying Figures, in which:

FIG. 1 is a schematic cross-sectional diagram (in the X-Z plane) of an example embodiment of a microchamber system that includes the nozzle system according to the disclosure;

FIG. 2 is a top-down view of the microchamber system (as seen in the X-Y plan) showing an example optical-access feature;

FIG. 3 is a cross-sectional view of the microchamber system as taken in the X-Z plane;

FIG. 4 is a close-up, cross-sectional view of the microchamber system of FIG. 3 that shows the nozzle system of the disclosure and also shows the localized process-gas atmosphere formed by the nozzle system within a central region of the process chamber;

FIG. 5 is a top-down view of the laser line formed on the surface of the substrate, and showing the laser line movement (scan) direction (arrow SD), which is defined by the wafer movement direction (arrow WD);

FIG. 6 is a close-up, top-down view of the microchamber system without the top member, showing the localized process-gas atmosphere formed in the central region of the process chamber surrounded by the gas curtain formed in a peripheral region of the process chamber; and

FIG. 7 is a close-up side view of the substrate with a film formed on the surface of the substrate by performing laser processing within the localized process-gas atmosphere according to the systems and methods disclosed herein.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute a part of this Detailed Description.

Cartesian coordinates are shown in some of the Figures for the sake of reference and are not intended to be limiting as to direction or orientation.

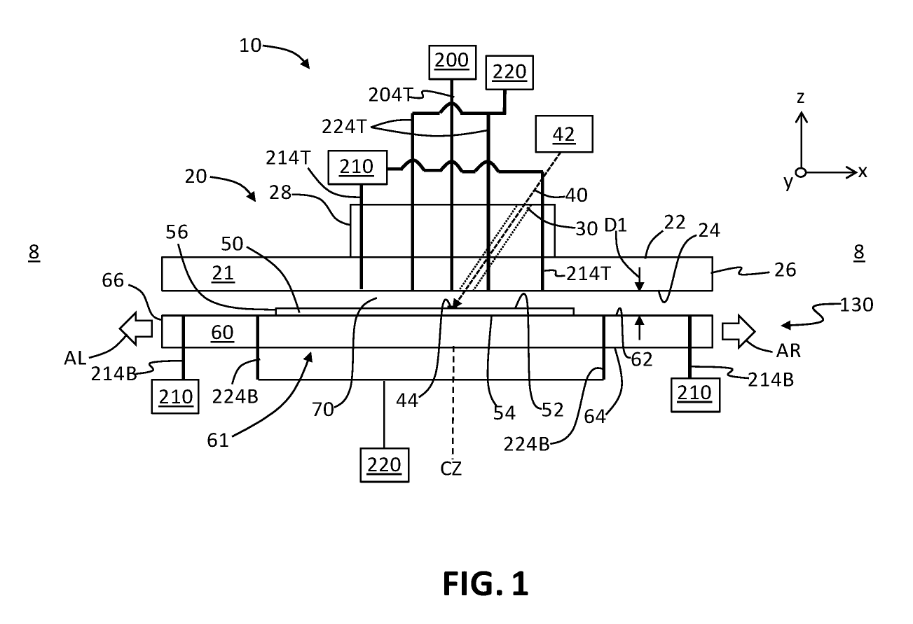

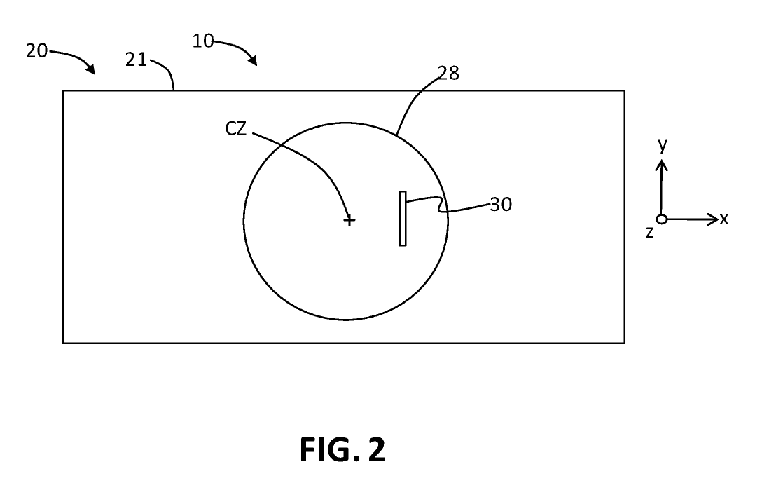

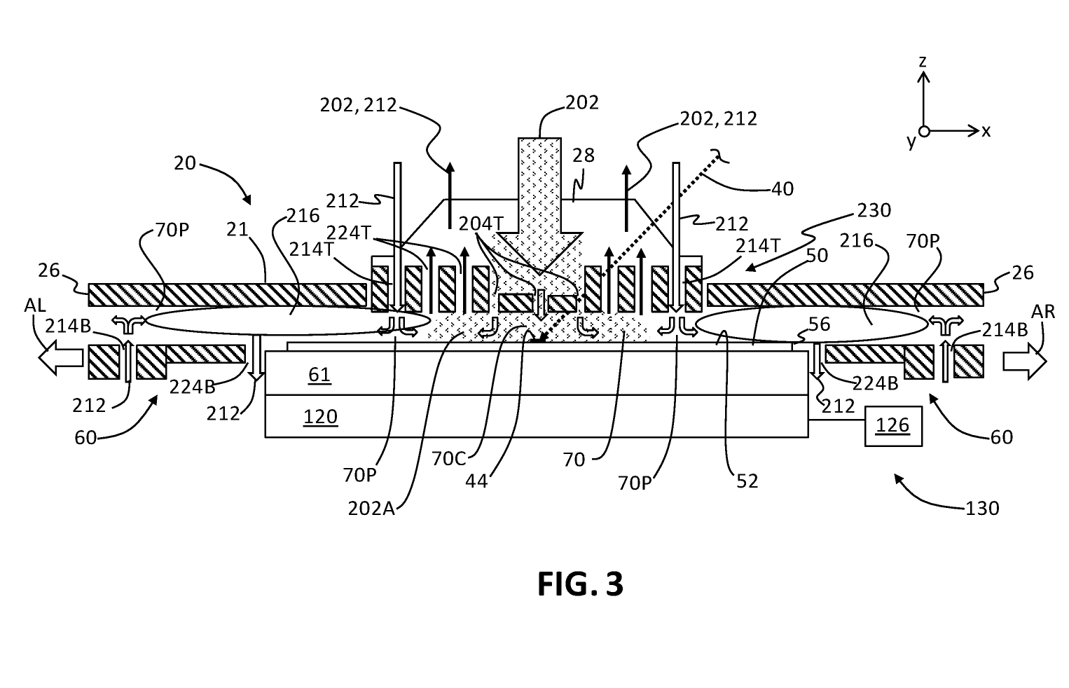

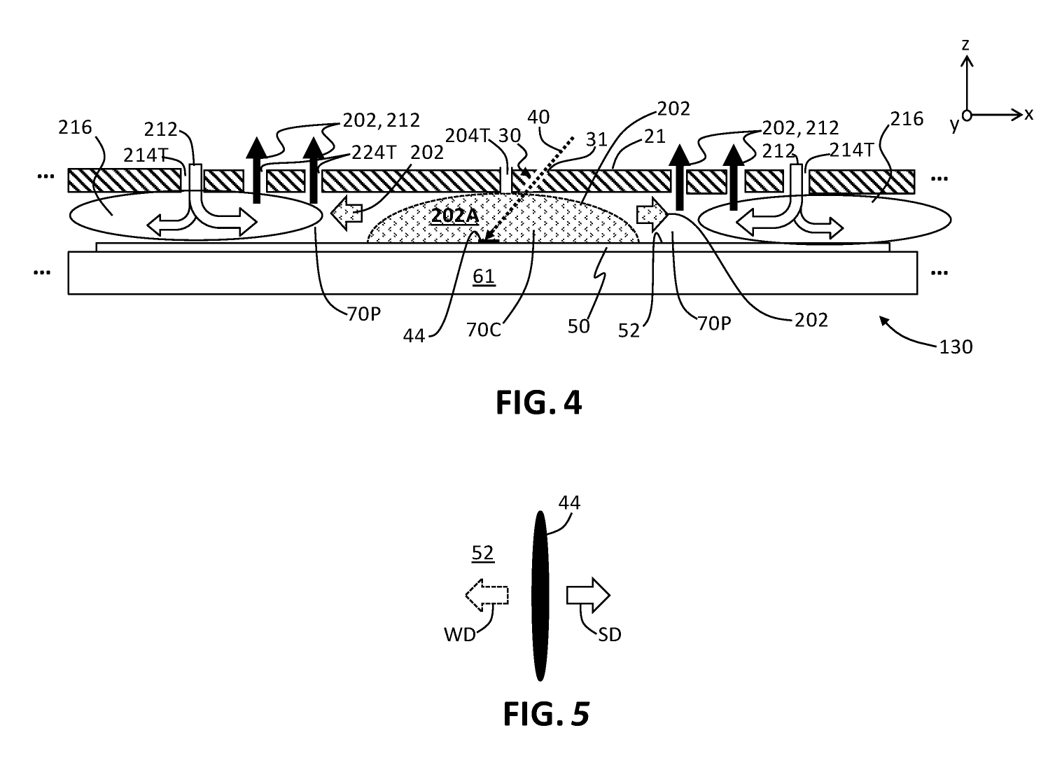

FIG. 1 is a schematic cross-sectional diagram (in the X-Z plane) of an example embodiment of a microchamber system (“system”) 10, while FIG. 2 is a top-down view of the system 10 (as seen in the X-Y plane). FIGS. 3 and 4 are more detailed cross-sectional views of an example of system 10 as seen in the X-Z plane. The system 10 has a Z-centerline CZ that runs in the Z-direction. The system 10 resides in an ambient environment 8 that may include air, or at least one reactive gas, such as oxygen. It may also include non-reactive gasses, such as neon or argon, or stable gases, such as nitrogen.

The system 10 includes a top member 20 having a plenum 21 with an upper surface 22, a lower surface 24 and an outer edge 26. The top member 20 includes or supports on the plenum 21 on the upper surface 22 along the Z-centerline CZ a process superstructure 28 that supports various gas lines and one or more optical-access features, as described below. In an example, the plenum 21 is generally rectangular or cylindrical in shape with the parallel upper and lower surfaces 22 and 24.

In an example, the top member 20 is cooled with a cooling system (not shown). In an example, the top member 20 includes at least one optical-access feature 30 that allows at least one laser beam 40 from a laser source 42 to pass through the top member 20. In an example, the at least one optical-access feature 30 comprises a straight-line channel or bore. In an example the optical-access feature 30 can include at least one window to prevent the exchange of gas between a chamber 70 and the ambient environment 8. In an example such as shown in FIG. 4, the optical-access feature 30 passes through both the plenum 21 and the process superstructure 28 and includes a window 31 that substantially transmits the laser beam 40.

The system 10 also includes a lower member 60 that defines or supports a chuck 61 or that surrounds a chuck 61. The chuck 61 has an upper surface 62, a lower surface 64 and an outer edge 66. The chuck 61 is generally cylindrical in shape and is centered on the Z-centerline CZ, with the upper surface 62 adjacent and parallel to the lower surface 24 of plenum 21. The upper surface 62 of chuck 61 and lower surface 24 of plenum 21 are spaced apart by a distance D1 in the range from 50 microns to 2 mm, thereby defining a chamber 70 with the height D1. The chuck 61 is shown in FIG. 1 as part of the lower member 60 by way of example. In other examples such as shown in FIG. 3, the chuck 61 can be a separate device, with the lower member 60 forming a ring member or skirt around the cylindrical chuck 61. Arrows AR and AL indicate that the lower member 60 and chuck 61 can move together in the x-direction to the right (+x direction) and to the left (−x direction), respectively.

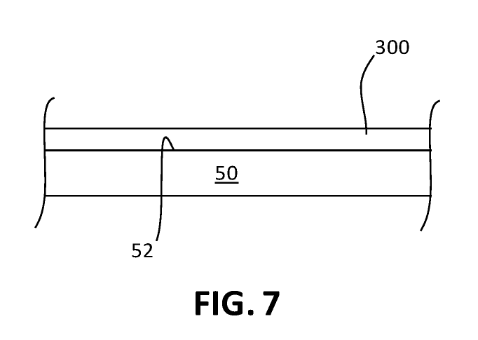

The upper surface 62 of chuck 61 is configured to support a semiconductor substrate (“substrate”) 50 having an upper surface 52, a lower surface 54 and an outer edge 56. In an example, the substrate 50 is a silicon wafer. The substrate 50 can be a product wafer that has undergone processing to create semiconductor devices and that is being further processed by the laser beam 40. In an example, the chuck 61 can be heated and, in a further example, is configured to heat the substrate 50 to a (wafer) temperature T_{w} of up to about 400° C. In an example, the at least one laser beam 40 comprises one or more process laser beams, i.e., one or more laser beams that can perform a laser process in the substrate 50 to form, for example, a film 300 such as a nitrogen-based dielectric film, as described below in connection with FIG. 7.

In an example, the chuck 61 and the lower member 60 are movable via the movement of a movable stage 120 (see FIG. 3) that supports the lower member 60 and the chuck 61. The movable stage 120 is operably connected to a positioner 126 configured to cause the movable stage 120 to move and to position the movable stage 120 as needed while also tracking the position of movable stage 120 relative to a reference position. The combination of the lower member 60, chuck 61 and movable stage 120 defines a stage assembly 130.

In an example, the movable stage 120 and chuck 61 are integrated to form either a unitary or a dual-component movable chuck that is operably connected to the positioner 126. The top member 20 is sufficiently long in the X-direction for the chuck 61 to move relative to the top member 20 so that laser beam 40 can expose the entire upper surface 52 of substrate 50 by scanning a laser line 44 formed by the laser beam 40 over the upper surface 52 of substrate 50. In an example, the laser line 44 is stationary and the scanning is performed by movement of substrate 50 beneath the laser line 44. FIG. 5 is a top-down view of an example laser line 44 formed on the upper surface 52 of substrate 50. The laser line 44 scans over the upper surface 52 of substrate 50 in a scan direction SD when the substrate 50 moves in a wafer direction WD.

With reference again to FIGS. 1, 3 and 4, the system 10 also includes a process-gas supply 200 that provides a process gas 202 to a central region 70C of the chamber 70 via one or more top process-gas conduits 204T that run through the top member 20. In an example, the process gas 202 is nitrogen-based. Examples of nitrogen-based process gasses include ammonia (NH₃), NO₂, N₂O and a H₂/N₂ mixture (e.g., 4% H₂) while an example curtain gas 212 can consist of one or more inert gases, such as neon, argon, helium and nitrogen. In an example, the systems and methods disclosed herein enable the use of a H₂/N₂ gas mixture where the H₂ concentration is greater than 4% because such small amounts of process gas are used and are well contained, as described below.

The system 10 also includes a first curtain-gas supply 210 that provides a curtain gas 212 (FIG. 3) to the chamber 70 to a peripheral region 70P via one or more top curtain-gas conduits 214T that run through the top member 20. Examples of the curtain gas 212 include one or more of nitrogen, argon, helium and neon.

The system 10 also includes a vacuum system 220 that communicates with the chamber 70 via top vacuum conduits 224T that run through the top member 20. The system 10 can also include an additional curtain-gas supply 210 that provides curtain gas 212 to the chamber 70 to a peripheral region 70P of the chamber 70 via one or more lower curtain-gas conduits 214B that run through the lower member 60 and that are located radially outward from the top curtain-gas conduits 214T. The system 10 can also include a second vacuum system 220 that communicates with the chamber 70 via lower vacuum conduits 224B that run through or that are otherwise formed in the lower member 60 and that are located at a radial distance between the top and lower curtain-gas conduits 214T and 214B. In an example, the system 10 utilizes only one curtain-gas supply 210 and one vacuum system 220 operably connected to the top and lower curtain-gas conduits 214T and 214B and the top and lower vacuum conduits 224T and 224B.

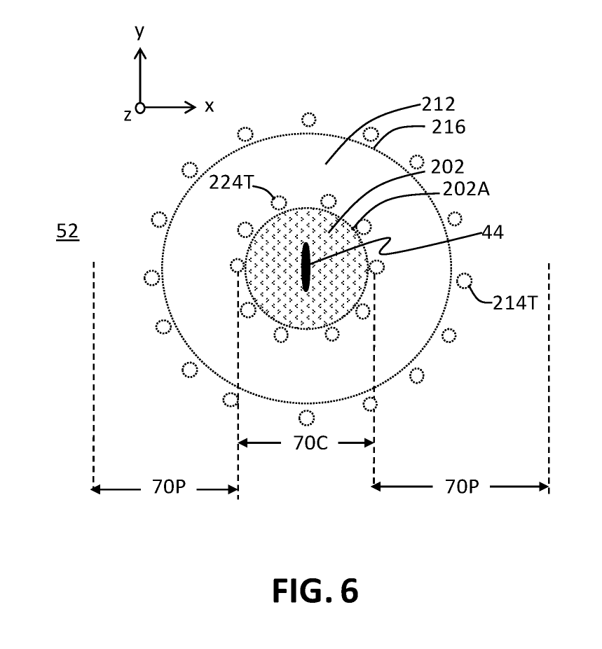

In an example, some or all of the aforementioned conduits are defined by one or more passages through either the top member 20, or the lower member 60, and may be defined by one or more spaces or gaps that reside between the chuck 61 and lower member 60. In an example, the top and lower curtain-gas conduits 214T and 214B and the top and lower vacuum conduits 224T and 224B are each constituted by an array of radially arranged conduits, as shown in FIG. 6 (introduced and discussed below). The process-gas supply 200 and the top process-gas conduit 204T, the curtain-gas supply 210 and the top and lower curtain gas conduits 214T and 214B, and the vacuum system 220 and the top and lower vacuum conduits 224T and 224B define a nozzle system 230 for the system 10.

The flow of curtain gas 212 in the peripheral region 70P of chamber 70, combined with the action of the applied vacuum using the top vacuum conduits 224T forms a gas curtain 216 made up of the curtain gas 212, with the gas curtain 216 surrounding the central region 70C. The flow of curtain gas 212 through the lower curtain-gas conduits 214B and the application of vacuum through the lower vacuum conduits 224B serves to further define gas curtain 216 by creating both an inward and an outward flow of curtain gas 212.

Meanwhile, the process gas 202 is injected into the central region 70C of chamber 70 via one or more top process-gas conduits 204T, whereupon the process gas 202 spreads radially outward until it encounters the innermost portion of gas curtain 216. The action of the vacuum applied between where the curtain gas 212 is injected and the central region 70C where the process gas 202 is injected, along with the gas curtain 216 in the peripheral region 70P, serves to draw away excess process gas 202 from the chamber 70 before it can spread radially outward into the peripheral region 70P.

The above process using the nozzle system 230 defines a localized process-gas atmosphere 202A of the process gas 202 in the central region 70C of the chamber 70 where the laser processing of the upper surface 52 of substrate 50 occurs. The localized process-gas atmosphere 202A has a pressure based on how fast and how much of the process gas 202 is fed into the central region 70C of chamber 70 by the process-gas supply 200.

FIG. 6 is a top-down view of the system 10 without the top member 20, showing the formation of localized process-gas atmosphere 202A surrounded by the gas curtain 216. FIG. 6 shows an example laser line 44 formed on the upper surface 52 of substrate 50 within the localized process-gas atmosphere 202A in connection with performing laser processing of the upper surface 52 of substrate 50 in the presence of the process gas 202. Also shown in FIG. 6 is an example configuration of the top vacuum conduits 224T and top curtain-gas conduits 214T of top member 20. In the example configuration, the top vacuum conduits 224T and top curtain-gas conduits 214T are radially arranged and concentric, with the top vacuum conduits 224T residing radially within the top curtain-gas conduits 214T.

The laser processing of upper surface 52 of substrate 50 is carried out in one example by moving the stage assembly 130 relative to the plenum 21 so that laser line 44 scans over the upper surface 52 of substrate 50 while irradiating the upper surface 52 of substrate 50 within the localized process-gas atmosphere 202A.

FIG. 7 is a close-up side view of substrate 50 with a film 300 formed on the upper surface 52 of substrate 50 via laser processing in the presence of process gas 202. In an example, the process gas 202 includes ammonia, which dissociates into N atoms and H atoms. The N atoms are then used in the laser process to form a nitride-based film 300. In an example, the process gas 202 includes or consists of ammonia and water vapor (H₂O), with the water vapor providing the oxygen to form the nitride-based oxide film 300 on the upper surface 52 of substrate 50.

Note that the process gas 202 flows into the central region 70C of chamber 70 and then out of the chamber 70 via the top vacuum conduits 224T located radially outward from the more central top process-gas conduit 204T. This flow of process gas 202 serves to replenish the localized process-gas atmosphere 202A with the process gas 202. The position of the top vacuum conduits 224T defines the size (i.e., radial extent) of the localized process-gas atmosphere 202A.

Note that in an example, the gas curtain 216 perform two main functions. The first function is to substantially contain the process gas 202 within the central region 70C of chamber 70 to define the localized process-gas atmosphere 202A, within which the upper surface 52 of substrate 50 can be laser processed in the presence of the process gas 202. The second main function is to prevent a substantial amount of the process gas 202 that forms the localized process-gas atmosphere 202A from escaping radially outwardly through the peripheral region 70P of chamber 70 and then to the ambient environment 8. In an example, the gas curtain 216 is formed such that any process gas 202 that manages to escape into the ambient environment 8 has a concentration less than a safety threshold amount or concentration, e.g., to no more than trace amounts of the process gas 202 as measurable in parts-per-million (ppm). In the example of using ammonia as the process gas 202, the safety threshold amount or concentration can be either the OSHA permission exposure limit (PEL) of 35 ppm or the NIOSH recommended exposure limit (REL) of 25 ppm.

An aspect of the disclosure is a method of laser processing the upper surface 52 of substrate 50 movably supported in the chamber 70 of system 10. The method includes providing the process gas 202 to the central region 70C of chamber 70, wherein the central region 70C includes the upper surface 52 of substrate 50. The method also includes providing the curtain gas 212 to the peripheral region 70P of chamber 70, wherein the peripheral region 70P also includes the upper surface 52 of substrate 50. The method also includes providing a vacuum to (i.e., forming a vacuum in) a region of chamber 70 between the central and peripheral regions 70C and 70P of the chamber 70. The vacuum removes the process gas 202 and curtain gas 212, thereby forming the localized process-gas atmosphere 202A adjacent the upper surface 52 of substrate 50 in the central region 70C of the chamber 70 and the gas curtain 216 of curtain gas 212 in the peripheral region 70P of the chamber 70. The method further includes irradiating the upper surface 52 of substrate 50 through the localized process-gas atmosphere 202A with a laser beam 40 that forms laser line 44 to perform a laser process on the upper surface 52 of substrate 50. In an example, the process gas 202 is nitrogen based, and the laser process forms a nitride-based oxide film 300 on the upper surface 52 of substrate 50.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A microchamber system for processing a surface of a substrate, comprising:
a top member having at least one optical-access feature sized to accommodate a laser beam that forms a laser line at the surface of the substrate;
a movable stage assembly spaced apart from and that moves relative to the top member to define a chamber having a central region and a peripheral region, the movable stage assembly including a chuck that supports the substrate;
a process-gas supply that contains a process gas and that is operably connected to the central region of the chamber by at least one process-gas conduit;
a curtain-gas supply that contains a curtain gas and that is operably connected to the peripheral region of the chamber by at least one curtain-gas conduit; and
a vacuum system operably connected to the chamber by at least one vacuum conduit that resides radially between the at least one process gas conduit and the at least one curtain-gas conduit so that when the process gas and the curtain gas are respectively flowed into the central and peripheral regions of the chamber, a localized process-gas atmosphere is formed in the central region of the chamber and a gas curtain of curtain gas is formed in the peripheral region of the chamber.

2. The microchamber system according to claim 1, further comprising a laser source that forms the laser beam, wherein the laser source is operably arranged outside of the chamber relative to the optical-access feature.

3. The microchamber system according to claim 1, wherein the curtain gas consists of one or more gasses selected from the group of gases consisting of: nitrogen, argon, helium and neon.

4. The microchamber system according to claim 1, wherein the process gas is one or more gasses selected from the group of gases consisting of: NH₃, N₂O, NO₂ and an H₂/N₂ mixture.

5. The microchamber system according to claim 1, wherein the process gas consists of ammonia and water vapor.

6. The microchamber system according to claim 1, wherein the at least one curtain-gas conduit includes a radially arranged array of curtain-gas conduits that run through the top member, wherein the at least one vacuum conduit includes a radially arranged array of vacuum conduits that run through the top member, and wherein the radially arranged array of vacuum conduits is concentric with and resides within the radially arranged array of curtain-gas conduits.

7. A method of laser processing a surface of a substrate movably supported in a chamber of a microchamber system, comprising:
providing a process gas to a central region of the chamber that includes the surface of the substrate;
providing a curtain gas to a peripheral region of the chamber that includes the surface of the substrate;
providing a vacuum to a region of the chamber between the central and peripheral regions of the chamber, wherein the vacuum removes process gas and curtain gas thereby forming a localized process-gas atmosphere adjacent the surface of the substrate in the central region of the chamber and a gas curtain of the curtain gas in the peripheral region of the chamber; and
irradiating the surface of the substrate through the localized process-gas atmosphere with a laser beam that forms a laser line to perform a laser process on the surface of the substrate.

8. The method according to claim 7, further comprising moving the substrate relative to the laser beam so that the laser line scans over the surface of the substrate.

9. The method according to claim 7, wherein the process gas includes ammonia.

10. The method according to claim 9, wherein the process gas consists of ammonia and water vapor.

11. The method according to claim 8, wherein the process gas is nitrogen-based, and wherein the laser process forms a nitride-based oxide film on the surface of the substrate.

12. The method according to claim 11, wherein the process gas is selected from the group of gases consisting of: NH₃, N₂O, NO₂, and an H₂/N₂ mixture.

13. The method according to claim 7, wherein the curtain gas consists of one or more gasses selected from the group of gases consisting of: nitrogen, argon, helium and neon.
